(19) United States
(12) Patent Application Publication
(10) Pub. No.: US 2010/0163556 A1
(43) Pub. Date: Jul. 1, 2010

(54) HIGH-FREQUENCY HEATING APPARATUS

(75) Inventors: Takayuiki Akashi, Nara (JP); Nobuhiro Ogawa, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/160,478

(22) PCT Filed: Jan. 11, 2007
(86) PCT No.: PCT/JP2007/050249

§ 371 Date: Jul. 10, 2008

(30) Foreign Application Priority Data
Jan. 17, 2006 (JP) 2006-008456

(51) Int. Cl. H05B 6/68

(52) U.S. Cl. 219/702

(57) ABSTRACT

An object of the invention is to detect the temperature of food and offer a good finish of cooking even in case a steam generator is arranged in a heating chamber.

The controller avoids using the temperature data of an area overlapping the steam generator out of the temperature data from the infrared sensor in the detection judgment of food temperature in order to prevent detection errors in case steam heating is selected.

### TECHNICAL FIELD

The present invention relates to a high-frequency heating apparatus that noncontact detects the temperature of food by way of a surface temperature detector and finishes the food to an appropriate temperature.

### BACKGROUND ART

In the related art, such high-frequency heating apparatus have generally used an infrared sensor to detect the surface temperature of food. In recent years, there have been manufactured a growing number of high-frequency heating apparatus including a heating chamber with a flat bottom face rather than a rotary disc on which food is put. This enhances flexibility of food position in the heating chamber, which requires improvement in the precision of detecting food temperatures using an infrared sensor.

To this end, a high-frequency apparatus has been proposed including that engages an infrared sensor having a plurality of infrared sensing elements to perform repeated scan in a predetermined direction in a heating chamber, detects the maximum temperature in the meantime, compares the maximum temperature with a predetermined value and determines the heating time (for example, refer to Patent Reference 1).

Various types of recent high-frequency heating apparatus have been made available on the market that feature convenience in high-frequency heating, a wide cooking range of electric heating, and the steam heating capability. There have been invented high-frequency heating apparatus including a steam generator in the heating chamber for steam heating (for example, refer to Patent Reference 2).
Patent Reference 1: JP-A-2002-168457
Patent Reference 2: JP-A-2004-44993

### DISCLOSURE OF THE INVENTION

### Problems that the Invention is to Solve

The related art high-frequency heating apparatus arrange an infrared sensor on the side wall in the upper area of a heating chamber and engage the infrared sensor to perform repeated scan by way of motor rotation. Assuming the rotary angle is constant, there arises a difference in the travel distance of a reading position of the infrared sensor between the front area and the innermost area with respect to the surface on which the infrared sensor is mounted. In other words, the travel distance is larger in the innermost area and smaller in the front area. Thus, it is necessary to adequately enhance the rotary angle of the infrared sensor so as to detect the temperature of food placed in the front area with respect to the surface on which the infrared sensor is mounted. In the innermost area, the range detected by the infrared sensor includes a uselessly detected area.

In case a steam generator is arranged in the heating chamber, the infrared sensor may erroneously read the temperature of the steam generator as well as the food temperature for a cooking menu using steam heating, thus resulting in a detection error. The entire steam generator is at a temperature as high as around 100° C. because of generated steam while the finish temperature of food is experimentally set to 70 to 80° C. depending on the cooking menu so as to offer food just right for eating. The infrared sensor reads the higher temperature of the steam generator instead of the temperature of the food to make erroneous detection judgment. This results in insufficient heating of food.

The invention has been accomplished to solve the problems with the related art. An object of the invention is to provide a high-frequency heating apparatus designed to offer a good finish of cooking by correctly detecting the temperature of food even in case a steam generator is arranged in a heating chamber.

### Means for Solving the Problems

In order to solve the problems with the related art, a high-frequency heating apparatus comprises: a heating chamber that accommodates food; a surface temperature detector arranged on the outer side wall of the heating chamber, that noncontact detects the temperature of food in the heating chamber; a moving part that operates the surface temperature detector so as to detect the temperature of a predetermined range in the heating chamber; and a controller that controls operation of the moving part and heating of food; and in that the detection range of the surface temperature detector changes in accordance with cooking menus.

### Advantage of the Invention

With the invention, the temperature of the steam generator is not detected and detection judgment is made only based on a rise in the food temperature even for a cooking menu using steam heating in the food heating process. This provides heating of food in an appropriate time for the food and an excellent finish.

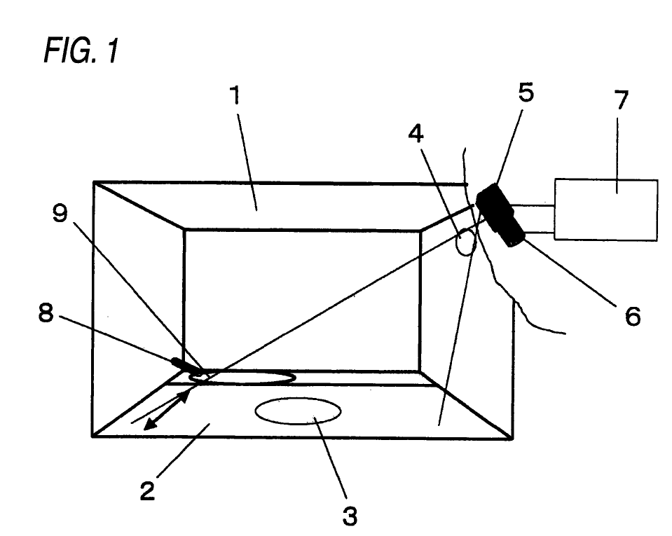

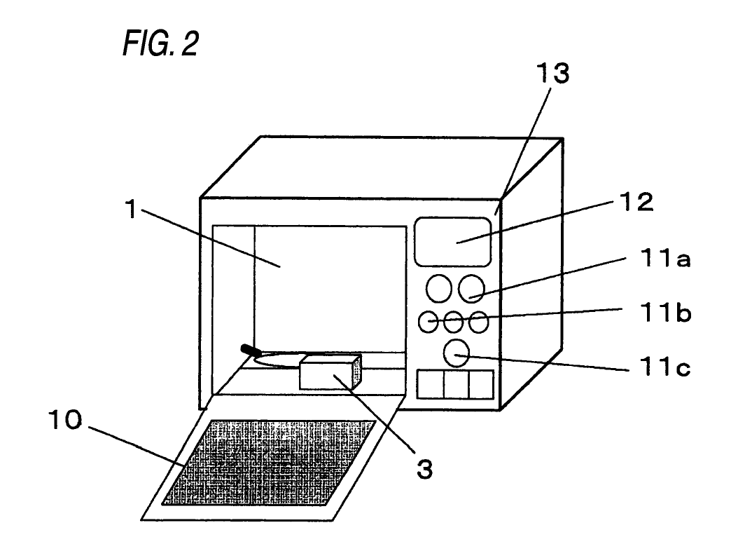

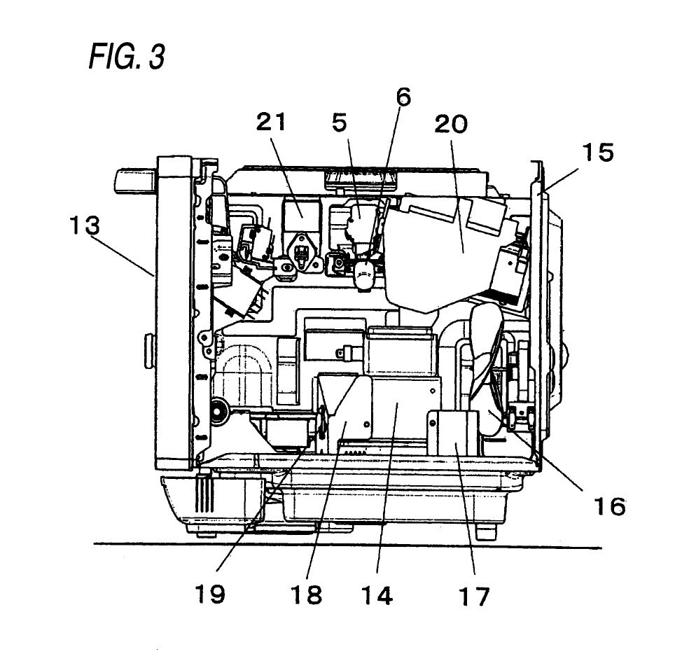

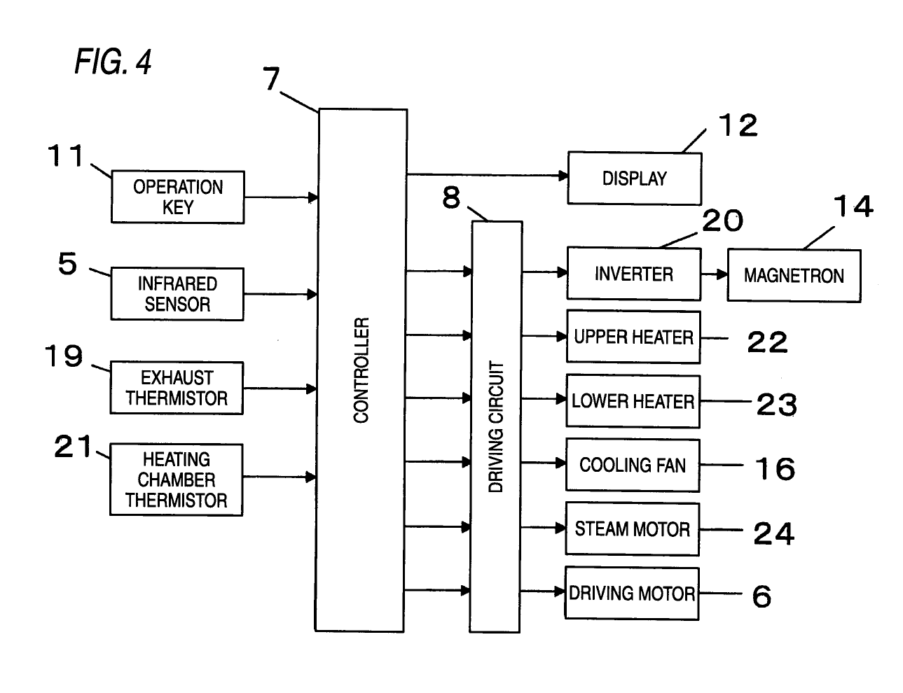

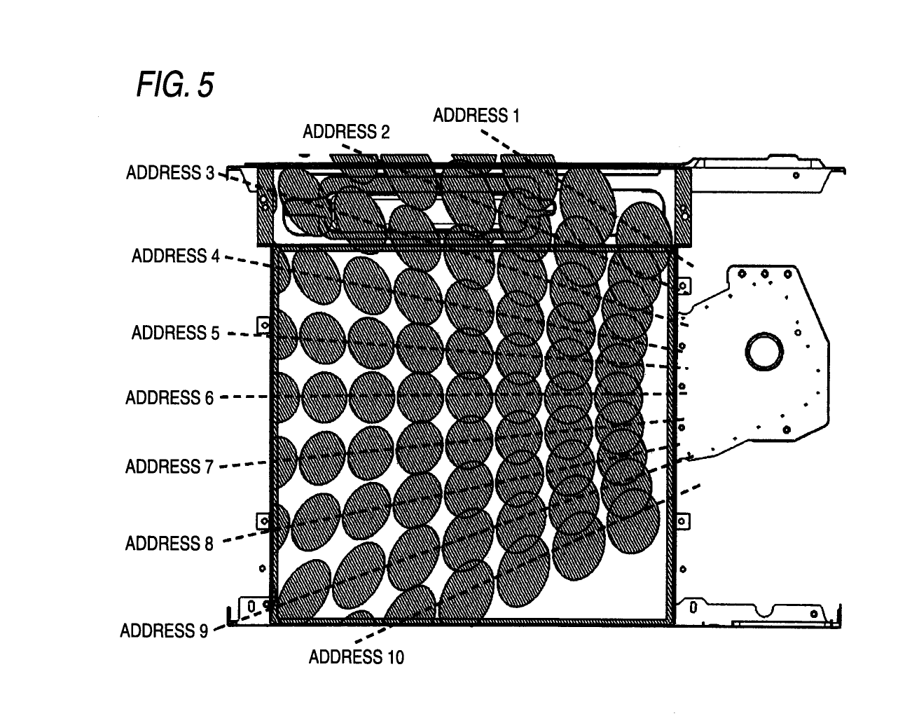

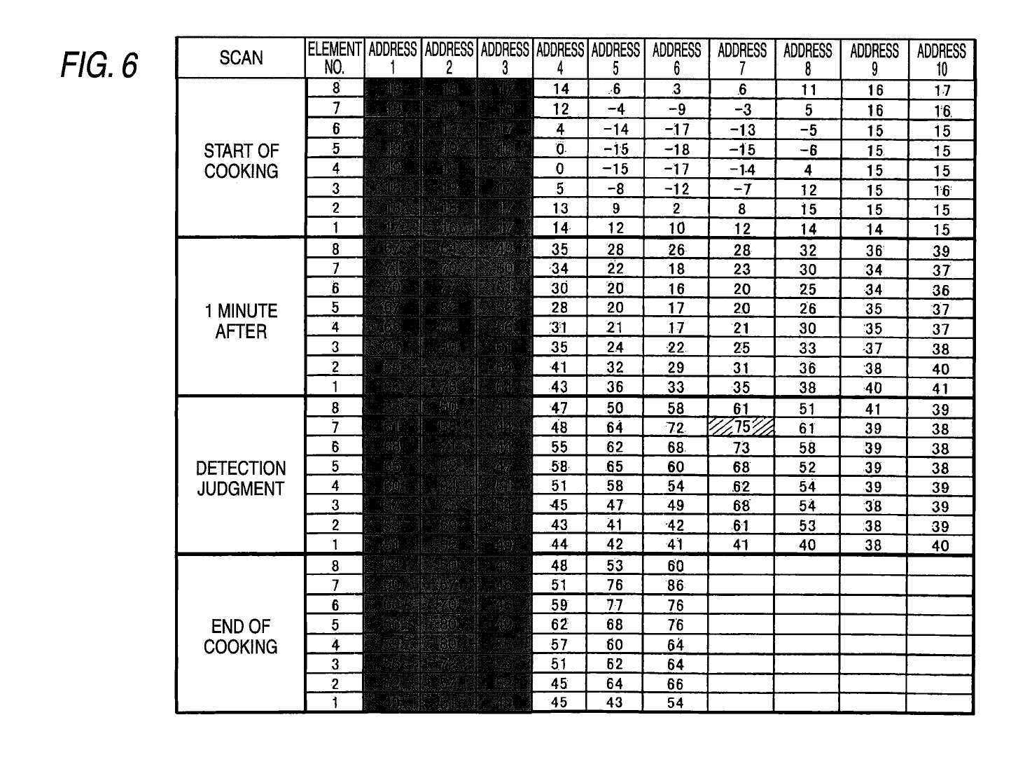

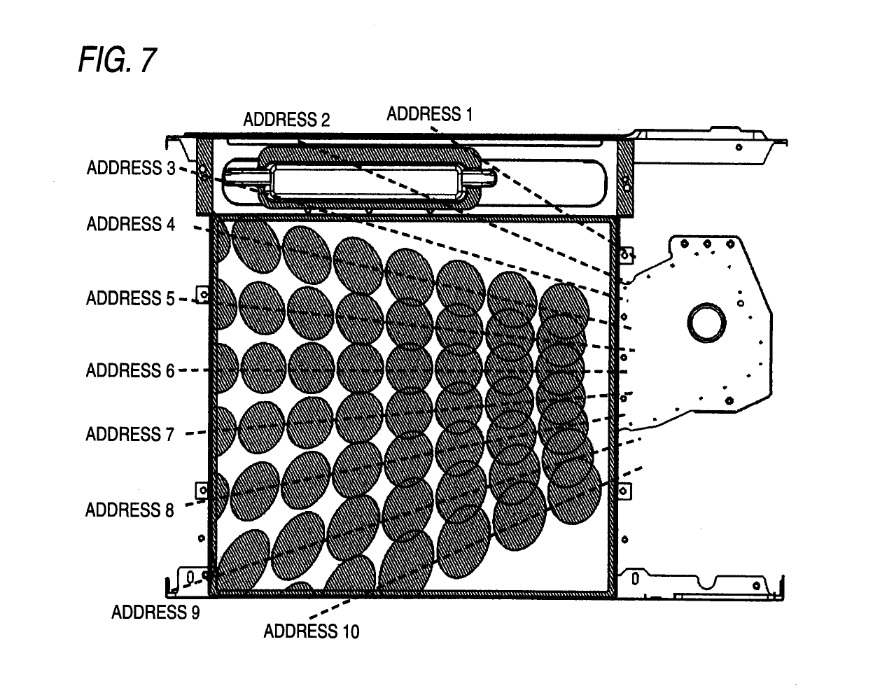

### BRIEF DESCRIPTION OF THE DRAWINGS

[FIG. 1] It is a schematic view of a system according to Embodiment 1 of the invention.

[FIG. 2] It is a block diagram of the main unit of a high-frequency heating apparatus according to Embodiment 1 of the invention.

[FIG. 3] It is a block diagram of the right face of the high-frequency heating apparatus according to Embodiment 1 of the invention.

[FIG. 4] It is a block diagram showing the configuration of control means.

[FIG. 5] It shows the temperature detection area for an infrared sensor according to Embodiment 1 of the invention.

[FIG. 6] It shows the detection data of the infrared sensor in a cooking process according to Embodiment 1 of the invention.

[FIG. 7] It shows the temperature detection area for an infrared sensor according to Embodiment 2 of the invention.

### DESCRIPTION OF THE REFERENCE NUMERALS AND SIGNS

1: Heating chamber

3: Food

5: Surface temperature detector

6: Driving motor

7: Controller

### BEST MODE FOR CARRYING OUT THE INVENTION

A first invention is a high-frequency heating apparatus comprising: a heating chamber that accommodates food; a surface temperature detector arranged on the outer side wall of the heating chamber, that noncontact detects the temperature of food in the heating chamber; a moving part that operates the surface temperature detector so as to detect the temperature of a predetermined range in the heating chamber; and a controller controls operation of the moving part and heating of food, in that the detection range of the surface temperature detector changes in accordance with cooking menus. This makes it possible to appropriately judge a rise in the temperature of food, thus providing an excellent finish of cooking.

A second invention is the high-frequency heating apparatus according to the first invention, further comprising a steam generator that heats an object to be heated with steam. This arrangement makes it possible to more appropriately judge rising in the temperature of food than ordinary high-frequency heating apparatus even when the steam generator is at a high temperature, thus providing an excellent finish of cooking.

A third invention is the high-frequency heating apparatus according to the second invention, in that the steam generator includes in the heating chamber an evaporation tray having a water-reservoir recess to generate steam by heating. With the evaporation tray in the heating chamber, it is possible to appropriately judge rising in the temperature at all times even in the presence of a high-temperature part, thus providing an excellent finish of cooking.

A fourth invention is the high-frequency heating apparatus according to the third invention, in that the change in the detection range of the surface temperature detector partially neglects the detection data acquired. The data range of the steam generator is previously indicated and the temperature of the steam generator is not used for detection of rising in the temperature of food even in case the temperature detector has acquired temperature data. This arrangement makes it possible to appropriately judge a rise in the temperature of food, thus providing an excellent finish of cooking.

A fifth invention is the high-frequency heating apparatus according to the third invention, in that the change in the detection range of the surface temperature detector changes the operating range of the sensor moving part. The temperature detection area without the steam generator is previously indicated. This makes it possible to appropriately judge a rise in the temperature of food, thus providing an excellent finish of cooking.

Embodiments of the invention will be described referring to figures. These embodiments are not intended to limit the invention.

### Embodiment 1

FIG. 1 is a schematic system view of a high-frequency heating apparatus according to the invention. FIG. 2 is a front view of the high-frequency heating apparatus according to Embodiment 1 of the invention with its opening/closing door open. FIG. 3 is a configuration diagram of a machine space viewed from the right face. FIG. 4 is a block diagram of an electric configuration.

As shown in FIG. 1, a disc 2 is inserted at the bottom face of a heating chamber 1. Food 3 is mounted on the disc 2. An opening 4 for temperature detection is arranged in the upper area of the side face of the heating chamber 1. The surface temperature of the food 3 in the heating chamber 1 is contactlessly detected by an infrared sensor 5 as a surface temperature detector arranged on the outer wall of the heating chamber 1 through the opening 4. The infrared sensor 5 is operated repeatedly by a driving motor 6 in a direction indicated by the arrow so as to detect the temperature of a predetermined range on the bottom face in the heating chamber 1. A controller 7 makes operation control of the driving motor 6, performs A/D conversion of a voltage obtained from the infrared sensor 5, and compares the resulting digital temperature data of the food 3 with the judgment value of the predetermined finish temperature of the food 3 to determine the heating time of the food 3. In the innermost area of the heating chamber 1 is arranged a water-reservoir recess 9 for boiling water supplied from a nozzle 8 to generate steam.

On the front face of the heating chamber 1, a door is arranged in an openable-closable fashion to protect the front face. Also arranged is an operation panel 13 including various operation keys 11 for the user to select a cooking menu and instruct start of cooking and a display unit 12 to provide necessary display information. On the rear side of the operation panel 13 is arranged a control board (not shown). The control board includes thereon a controller 7 composed of a microcomputer, a driving circuit 14 for operating heating means, and the like. Behind the operation panel is arranged a machine space.

The machine space includes a magnetron 14 as a high-frequency generator on the right wall of the heating chamber 1. To the right of the magnetron 14 are arranged a cooling fan 16 mounted on a rear plate 15 and an air guide A 17 for cooling the magnetron 14. To the left of the magnetron 14 is arranged an air guide C18 for blowing air into the heating chamber 1. The air guide C 18 includes an exhaust thermistor 19 for detecting the temperature of the magnetron 14. High-frequency waves oscillated by the magnetron 14 supply microwaves into the heating chamber 1 from a power feed inlet (not shown) arranged on the bottom face of the main unit via a waveguide (not shown). Above the magnetron 14 is arranged an inverter 20 for varying the output of the magnetron 14. Between the inverter 20 and a lamp 21 for illuminating the interior of the heating chamber 1 is arranged an infrared sensor 5.

FIG. 4 shows a control block. Referring to FIG. 4, signals from various operation keys 11 including a start switch, the infrared sensor 5, an exhaust thermistor 19 for detecting the temperature of the magnetron 14 as a high-frequency generator, and a heating chamber thermistor 21 for detecting the temperature in the heating chamber 1 are inputted to the controller 7. The controller 7 displays information on the cooking time and accessories on the display unit 12 in accordance with a stored program based on these signals as well as controls the magnetron 14, an upper heater 22, a lower heater 23, a cooling fan 16, a steam heater 24, and a driving motor 6 via the driving circuit 14. The magnetron 14 is controlled via an inverter 20 so that its output may be controlled. For example, it is possible to simultaneously use the steam heater 24 (1000 W) and high-frequency output (300 W) within a limited capacity.

Operation of the high-frequency heating apparatus thus configured will be described.

FIG. 5 shows the temperature detection range of the infrared sensor according to the invention. FIG. 6 is a summary of the temperature data detected by the infrared sensor according to an embodiment of the invention. The infrared sensor includes eight infrared elements arranged in the shape of straight lines. The infrared sensor is driven normal to the straight lines to detect temperatures at 10 different angles (addresses 1 to 10 depending on the angle). Temperatures at a total of 80 (8×10=80) locations are detected.

When the user places frozen “SHUMAI” (meat dumpling) in the heating chamber 1 and selects a “steam heating” key as an operation key 11b to start cooking, the controller 7 outputs 1000 W from the steam heater 24 and 300 W of high-frequency heating. At the same time, the controller 7 starts to drive the driving motor 6 and obtains data of eight elements at addresses 1 to 10, that is, 80 data items. Minus temperatures are detected at addresses 5 to 8 and the controller 7 recognizes that frozen food is placed. Addresses 1 to 3 scans data on the water-reservoir recess 9. The values obtained at addresses 1 to 3 at the start of cooking are around 19° C., nearly the same as the room temperature.

At the same time as the start of cooking, the steam heater 24 for generating steam is heated. With a delay of 30 seconds, 10 cc of water is supplied from the nozzle 8. In one minute later, steam is generated from the water-reservoir recess 9. The data of Addresses 1 to 3 has already exceeded 80° C. The temperature is below 100° C. although steam is generated. This data is slightly lower than 100° C. because the data is obtained as an integral value on the detection area for the infrared sensor 5; data of the peripheral area as well that of the steam generator is obtained.

At this time, the temperature of the food for which a minus temperature is detected at the start of cooking has risen only to 16 through 25° C. The invention is designed to make detection judgment when the food temperature has reached 75° C. Control is made to perform additional heating for a time period obtained by multiplying the heating time elapsed until 75° C. is reached by 0.4 (experimentally obtained coefficient) to terminate cooking.

While a rise in the temperature of the water-reservoir recess 9 has been erroneously detected as a rise in the temperature of food in the related art, the invention intentionally avoids using the data of addresses including the water-reservoir recess (addresses 1 to 3 in this invention) and detection judgment has not taken place yet at this point in time.

In a minute, the controller 7 stops heating of the steam heater 24 and changes the control value of the inverter 20 to set the high-frequency output to 600 W. The water remaining in the water-resorvoir recess 9 is transformed into steam with the remaining heat in the steam heater 24. Food is gradually heated and 75° C. is detected at the element 7 at address 7 when 2 minutes 40 seconds has elapsed. The controller 7 calculates the additional heating time of 64 seconds by multiplying the time 2 minutes 40 seconds taken up to detection of 75° C. by 0.4. In this experimental cooking, 3 minutes 44 seconds was the total cooking time.

The actual temperature of SHUMAI is 65 to 95° C., which is just right for eating. Steam is generated, which has served to keep fresh and moist the coat of SHUMAI.

The data of the steam generator is not used only in case steam heating is selected. In case another menu such as heating or vegetable heating is selected, steam heating is not used in cooking and temperature data of addresses 1 to 10 is used thus detecting temperatures of a wider range.

### Embodiment 2

Embodiment 2 of the invention will be described referring to FIG. 7. For the same or equivalent sections as those in Embodiment 1, description is omitted or simplified.

When the user places frozen SHUMAI in the heating chamber and selects a “steam heating” key to start cooking, the controller 7 outputs 1000 W from the steam heater 24 and 300 W of high-frequency heating. At the same time, the controller 7 starts to drive the driving motor and obtains data of eight elements at addresses 4 to 10, that is, 56 data items.

In this embodiment, the area covering addresses 1 to 3 is not driven unlike Embodiment 1. This method takes 0.5 seconds to acquire the data of an address and proceed to the next address. The time required for three addresses during a single scan is 1.5 seconds (0.5 seconds multiplied by 3). This reduces the scan time by 1.5 seconds corresponding to three addresses for each scan.

While the acquisition count of food temperature per minute is 12 in Embodiment 1, the acquisition count is increased to 17 in Embodiment 2. The larger acquisition count of food temperature means that opportunities of comparison are more frequent to determine whether a target temperature is reached, improving the precision of detecting the time required for detection judgment, thus stabilizing the finish of food.

The area covering the steam generator is excluded from the detection area only in case steam heating is selected. In case another menu such as heating or vegetable heating is selected, steam heating is not used in cooking and temperature data of addresses 1 to 10 is used thus detecting temperatures of a wider range.

While the invention has been described in detail and in terms of specific embodiments, those skilled in the art will recognize that various changes and modifications can be made in it without departing the spirit and scope thereof.

This application is based on the Japanese Patent Application No. 2006-8456 filed Jan. 17, 2006 and its content is herein incorporated by reference.

### INDUSTRIAL APPLICABILITY

As described above, the high-frequency heating apparatus according to the invention excludes the temperature data of the steam generator from the temperature detection data of the infrared sensor. This allows detection judgment that is only based on a rise in the temperature of food, thereby controlling the heating process in an optimum cooking time and offering an excellent finish of food.

1. A high-frequency heating apparatus comprising:
a heating chamber that accommodates food;
a surface temperature detector arranged on the outer side wall of the heating chamber, that noncontact detects the temperature of food in the heating chamber;
a moving part that operates said surface temperature detector so as to detect the temperature of a predetermined range in said heating chamber; and
a controller that controls operation of said moving part and heating of food;
wherein the detection range of the surface temperature detector changes in accordance with cooking menus.

2. The high-frequency heating apparatus according to claim 1, wherein the heating chamber receives steam supplied from a steam generator.

3. The high-frequency heating apparatus according to claim 2, wherein the steam generator includes in said heating chamber an evaporation tray having a water-reservoir recess for generating steam by heating.

4. The high-frequency heating apparatus according to claim 3, wherein the change in the detection range of the surface temperature detector partially neglects the detection data acquired.

5. The high-frequency heating apparatus according to claim 3, wherein the change in the detection range of the surface temperature detector changes the operating range of the moving part.
